(19) United States
(12) Patent Application Publication
(10) Pub. No.: US 2026/0351783 A1
(43) Pub. Date: Nov. 5, 2026

(54) BATTERY MODULE WITH PRESSURE RELIEF AND EXPLOSION-PROOF FUNCTIONS, AND BATTERY BOX

(71) Applicant: Jiade Energy Technology (Zhuhai) Co., Ltd., Zhuhai (CN)

(72) Inventors: Jing ZHANG, Zhuhai (CN); Yonghong LI, Zhuhai (CN); Tiantong DAI, Zhuhai (CN); Kaiyi LU, Zhuhai (CN)

(21) Appl. No.: 19/709,128

(22) Filed: Jun. 16, 2026

Related U.S. Application Data
(63) Continuation of application No. PCT/CN2025/092017, filed on Apr. 29, 2025.

(30) Foreign Application Priority Data
May 27, 2024 (CN) 2024106605641

(51) Int. Cl. H01M 50/342; H01M 10/48; H01M 10/613; H01M 10/647; H01M 10/6554; H01M 10/658; H01M 50/209; H01M 50/507

(52) U.S. Cl. CPC H01M 50/3425; H01M 10/482; H01M 10/613; H01M 10/647; H01M 10/6554; H01M 10/658; H01M 50/209; H01M 50/507

(57) ABSTRACT

The present disclosure discloses a battery module with a compact structure, low production costs, and pressure relief and explosion-proof functions, and a battery box. The battery module includes a battery securing module, wherein both ends of the battery securing module are sequentially provided with a temperature-resistant pressure relief module, a check valve heat sink plate, and a thermal barrier wall; a plurality of cells are arranged in an array within the battery securing module; the temperature-resistant pressure relief module is provided with a plurality of pressure relief cavity assemblies arranged in an array at end portions of the cells; a plurality of intersecting pressure relief guide grooves are provided on a surface of the temperature-resistant pressure relief module; each of the plurality of pressure relief cavity assemblies comprises a pressure relief hole disposed at an end portion of a corresponding one of the cells.

### CROSS-REFERENCE TO RELATED APPLICATIONS

This application is a continuation of International Application No. PCT/CN2025/092017, filed on Apr. 29, 2025, which claims priority to Chinese Patent Application No. 202410660564.1, filed on May 27, 2024. All of the aforementioned applications are incorporated herein by reference in their entireties.

### TECHNICAL FIELD

The present disclosure relates to the technical field of power batteries, and in particular to a battery module with pressure relief and explosion-proof functions, and a battery box.

### BACKGROUND

Conventional battery packs are generally formed by connecting a plurality of battery cells in series and/or in parallel and then encapsulating them in a housing. However, due to space constraints, it is difficult to achieve an optimal balance among space utilization, cost, and the isolation and discharge of thermal runaway under abnormal conditions.

Currently, in small-batch custom power batteries, due to limitations in order quantity, cost, space, and technical investment, the primary focus is generally placed on the Battery Management System (BMS), and separate design measures for thermal runaway protection of battery cells are rarely implemented. Although safety management systems for thermal runaway of battery cells exist in new energy vehicles, such systems are complex and costly, and are not suitable for small-batch custom power battery packs. The present disclosure addresses the above-mentioned issues by creatively providing a low-cost solution with pressure relief and explosion-proof functions, which is applicable to small-batch custom power batteries.

### SUMMARY

The technical problem to be solved by the present disclosure is to overcome the drawbacks of the prior art, and to provide a battery module with a compact structure, small space requirements, low production costs, and pressure relief and explosion-proof functions, and a battery box.

The present disclosure adopts the following technical solutions. The present disclosure includes a battery module with pressure relief and explosion-proof functions, and a battery box. The battery module includes a battery securing module, wherein both ends of the battery securing module are sequentially provided with a temperature-resistant pressure relief module, a check valve heat sink plate, and a thermal barrier wall; a plurality of mounting cavities are arranged in an array within the battery securing module, wherein each of the plurality of mounting cavities is provided with a cell fitted therein, and each of the plurality of mounting cavities exposes an end portion of the cell; the temperature-resistant pressure relief module is attached to the end portion of the battery securing module; the temperature-resistant pressure relief module is provided with a plurality of pressure relief cavity assemblies arranged in an array, and each of the plurality of pressure relief cavity assemblies is disposed at the end portion of the cell; a plurality of pressure relief guide grooves are provided on a surface of the temperature-resistant pressure relief module, and the plurality of pressure relief guide grooves intersect each other; a lateral one of the plurality of pressure relief guide grooves is disposed between each two of the laterally adjacent pressure relief cavity assemblies, and a longitudinal one of the plurality of pressure relief guide grooves is disposed between each two of the vertically adjacent pressure relief cavity assemblies; each of the plurality of pressure relief cavity assemblies includes a pressure relief hole disposed at the end portion of the cell, and valve body stoppers disposed at an upper end of the pressure relief hole and a lower end of the pressure relief hole; the check valve heat sink plate is configured to match an outer contour of the temperature-resistant pressure relief module and is attached to end portions of the two valve body stoppers; a plurality of vertically folded check valve tabs are arranged in an array on the check valve heat sink plate; one of the check valve tabs is attached to both sides of the two valve body stoppers on the pressure relief hole, a length of the one of the check valve tabs is greater than a distance between the two valve body stoppers on the pressure relief hole, and a height of each of the check valve tabs is configured to match a height of each of the two valve body stoppers; whereby, under a joint action of a respective one of the pressure relief cavity assemblies and the check valve heat sink plate, the cell forms an independent pressure relief cavity; when the cell is in a normal state, the check valve tabs of the pressure relief cavity are in a closed and attached state; and when the cell undergoes thermal runaway and ejects material, the check valve tabs are opened to relieve pressure and the ejected material is discharged through the pressure relief guide grooves.

Further, the check valve heat sink plate is integrally formed from a highly thermally conductive material; a plurality of rectangular openings are arranged in an array on the check valve heat sink plate; two side walls of each of the plurality of rectangular openings are provided with the vertically folded check valve tabs; and the two check valve tabs on each of the plurality of rectangular openings are respectively attached to a left side wall of a corresponding one of the pressure relief cavity assemblies and a right side wall of an adjacent one of the pressure relief cavity assemblies.

Further, the length of each of the check valve tabs is smaller than a length of a respective one of the rectangular openings; and a middle portion of each of the check valve tabs connects to a respective one of the rectangular openings, and each of two end portions of each of the check valve tabs and a respective one of the rectangular openings define a slot gap.

Further, the battery securing module and the temperature-resistant pressure relief module are each made of a fire-resistant high-temperature-resistant thermally insulating material, and the temperature-resistant pressure relief module is configured to match an end surface of the battery securing module, so that the temperature-resistant pressure relief module is tightly attached to the end surface of the battery securing module; the thermal barrier wall is made of a high-temperature-resistant, low-thermal-conductivity lightweight material; the thermal barrier wall covers the entire check valve heat sink plate to confine heat of the battery module to be directionally released solely through the vertically folded check valve tabs and to be discharged through the pressure relief guide grooves; and the cell is in communication with the plurality of pressure relief guide grooves, such that pressure is configured to be instantly released.

Further, the temperature-resistant pressure relief module is a fire-resistant high-temperature-resistant thermally insulating rectangular plate; a spacer block is disposed between the two valve body stoppers of each of the pressure relief cavity assemblies; the pressure relief hole extends through the fire-resistant high-temperature-resistant thermally insulating rectangular plate and the spacer block; both outer sides and an upper end of the fire-resistant high-temperature-resistant thermally insulating rectangular plate are provided with sealing baffles.

Further, bus bars are further disposed between the battery securing module and the temperature-resistant pressure relief module, and the bus bars are configured to connect the cells in series.

Still further, the battery box includes a box housing, wherein a plurality of mounting compartments are provided in the box housing, and the above-mentioned battery module is installed in each of the plurality of mounting compartments; each of two ends of a bottom portion of the battery module is provided with a heat dissipation spacer block; a longitudinal one of the pressure relief guide grooves is disposed between two adjacent heat dissipation spacer blocks at the same end; and a pressure relief valve is provided at a center of a bottom portion of each of the plurality of mounting compartments.

Further, the battery box further includes a cover configured to fit the box housing; a pressure sensor and a controller are further provided in the box housing; and the pressure relief valve and the pressure sensor are each electrically connected to the controller.

The present disclosure provides the following beneficial effects: 1. The configuration of the temperature-resistant pressure relief module, the check valve heat sink plate, and the thermal barrier wall allows heat within the battery module to be quickly and effectively conducted to the outside for dissipation. 2. The temperature-resistant pressure relief module is provided with pressure relief holes at the explosion-proof valve positions corresponding to each cell, and intersecting pressure relief guide grooves are additionally provided on the surface of the temperature-resistant pressure relief module, thereby maximizing the pressure relief space. 3. The use of an integrally formed check valve heat sink plate that tightly cooperates with the temperature-resistant pressure relief module results in low production costs. The check valve tabs are vertically folded and attached to two sides of the two valve body stoppers. Thus, when a cell undergoes thermal runaway and ejects material, the check valve tabs are forced open to relieve pressure, and the ejected material is discharged through the pressure relief guide grooves. For other normal cells, the check valve tabs of their respective pressure relief cavities remain in a closed and attached state, so that the heat generated by the faulty cell during thermal runaway ejection does not affect the other cells within the same battery module.

### BRIEF DESCRIPTION OF THE DRAWINGS

FIG. 1 is a schematic structural diagram of a battery module;

FIG. 2 is an exploded schematic diagram of the battery module;

FIG. 3 is an internal cross-sectional view of the battery module;

FIG. 4 is an enlarged schematic view of portion B in FIG. 2;

FIG. 5 is an enlarged schematic view of portion C in FIG. 2;

FIG. 6 is a schematic structural diagram of a battery box;

FIG. 7 is an exploded schematic diagram of the battery box.

### DETAILED DESCRIPTION OF THE EMBODIMENTS

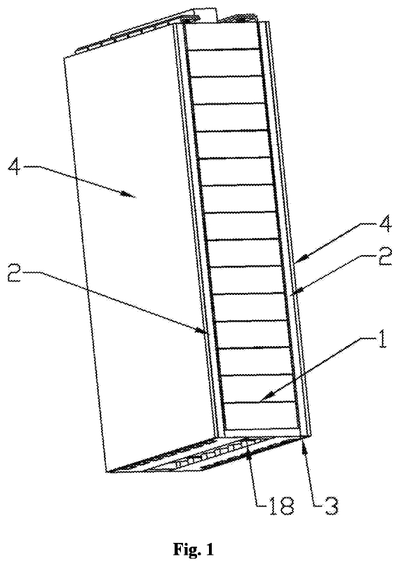

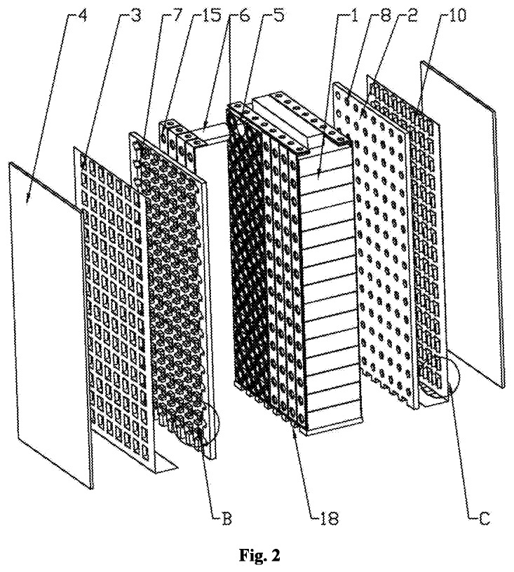

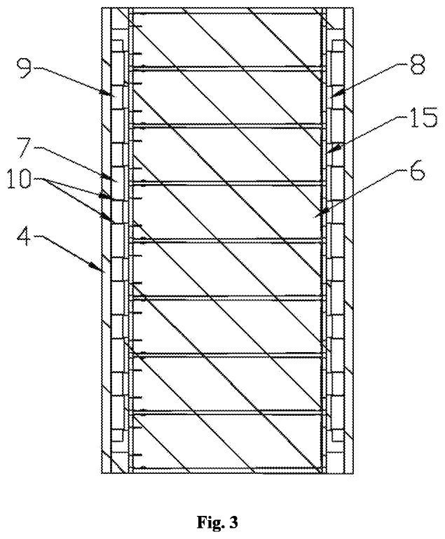

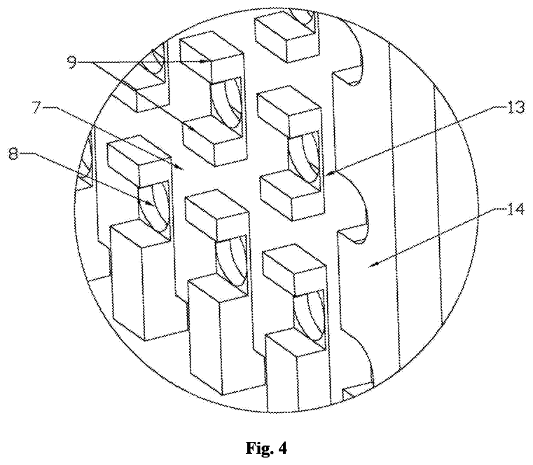

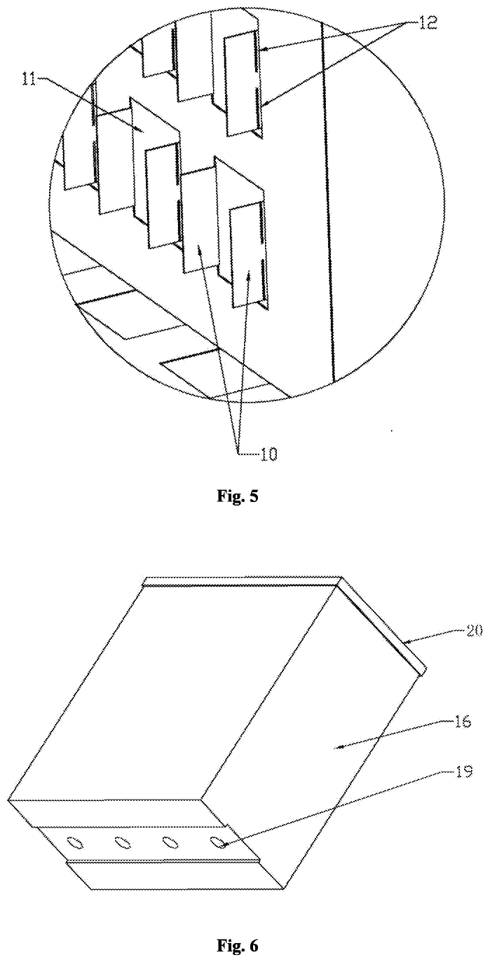

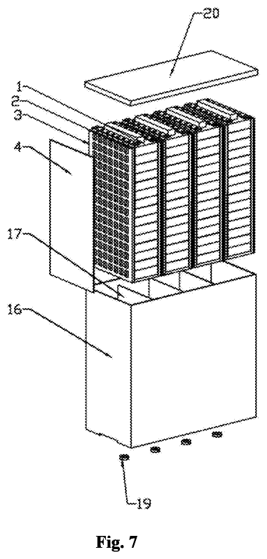

As shown in FIG. 1 to FIG. 7, in this embodiment, the present disclosure includes a battery module with pressure relief and explosion-proof functions, and a battery box. The battery module includes a battery securing module 1. Both ends of the battery securing module 1 are sequentially provided with a temperature-resistant pressure relief module 2, a check valve heat sink plate 3, and a thermal barrier wall 4. This configuration effectively saves an internal installation space of the battery module. A plurality of mounting cavities 5 are arranged in an array within the battery securing module 1. Each of the plurality of mounting cavities 5 is provided with a cell 6 fitted therein, and each of the plurality of mounting cavities 5 exposes an end portion of the cell 6. This configuration allows the cell 6 to be assembled in an individual space of the battery securing module 1.

The battery securing module 1 and the temperature-resistant pressure relief module 2 are each made of a fire-resistant high-temperature-resistant thermally insulating material. The temperature-resistant pressure relief module 2 is configured to match an end surface of the battery securing module 1, so that the temperature-resistant pressure relief module 2 is tightly attached to the end portion of the battery securing module 1, thereby isolating the exposed end portion of the cell 6 into individual spaces. The temperature-resistant pressure relief module 2 is provided with a plurality of pressure relief cavity assemblies arranged in an array, and each of the plurality of pressure relief cavity assemblies is disposed at the end portion of the cell 6. A plurality of pressure relief guide grooves 7 are provided on a surface of the temperature-resistant pressure relief module 2, and the plurality of pressure relief guide grooves 7 intersect each other. A lateral one of the plurality of pressure relief guide grooves 7 is disposed between each two of the laterally adjacent pressure relief cavity assemblies, and a longitudinal one of the plurality of pressure relief guide grooves 7 is disposed between each two of the vertically adjacent pressure relief cavity assemblies. Each of the plurality of pressure relief cavity assemblies includes a pressure relief hole 8 disposed at the end portion of the cell 6, and two valve body stoppers 9 disposed at an upper end of the pressure relief hole 8 and a lower end of the pressure relief hole 8. The temperature-resistant pressure relief module 2 is provided with the pressure relief hole 8 at a position corresponding to an explosion-proof valve at the end portion of the cell 6, and is further provided with the intersecting pressure relief guide grooves 7 on the surface of the temperature-resistant pressure relief module 2, thereby maximizing the pressure relief space. When a cell 6 undergoes thermal runaway, the generated high-speed gas flow and heat can be instantaneously relieved to all surrounding pressure relief guide grooves 7, preventing accumulation of heat and pressure.

The check valve heat sink plate 3 is made of a highly thermally conductive material, is shaped to match an outer contour of the temperature-resistant pressure relief module 2, and is attached to end portions of the valve body stoppers 9. A plurality of vertically folded check valve tabs 10 are arranged in an array on the check valve heat sink plate 3. One of the check valve tabs 10 is attached to both sides of the two valve body stoppers 9 on the pressure relief hole 8. A length of the one of the check valve tabs 10 is greater than a distance between the two valve body stoppers 9 on the pressure relief hole 8, and a height of each of the check valve tabs 10 is configured to match a height of each of the two valve body stoppers 9. Thus, under a joint action of a respective one of the pressure relief cavity assemblies and the check valve heat sink plate 3, the cell 6 forms an independent pressure relief cavity. In this configuration, the check valve heat sink plate 3, in a normal state, tightly cooperates with the temperature-resistant pressure relief module 2 to achieve a sealing effect. By providing the vertically folded check valve tabs 10 attached to both sides of the two valve body stoppers 9, the cell 6 is individually contained in the pressure relief cavity. When the cell 6 is in a normal state, the check valve tabs 10 of the pressure relief cavity are in a closed and attached state. When the cell 6 undergoes thermal runaway and ejects material, the increased pressure caused by the thermal runaway forces the check valve tabs 10 open to relieve pressure, and the ejected material is discharged through the pressure relief guide grooves 7. Since the cell 6 is in communication with the plurality of pressure relief guide grooves 7, the pressure can be instantly released. Moreover, the check valve tabs 10 are unidirectional, allowing opening only outward but not inward. Therefore, the pressure relief cavity corresponding to a normal cell 6 is in a closed state, and the heat generated by the faulty cell during thermal runaway ejection does not affect the other cells 6 within the same battery module.

In this embodiment, the thermal barrier wall 4 is made of a high-temperature-resistant, ultra-low-thermal-conductivity lightweight material. The thermal barrier wall 4 covers the check valve heat sink plate 3, thereby limiting heat of the entire battery module to directional conduction solely through the pressure relief guide grooves 7 and the check valve tabs 10, without affecting adjacent battery modules.

In this embodiment, a plurality of rectangular openings 11 are arranged in an array on the check valve heat sink plate 3. Two side walls of each of the plurality of rectangular openings 11 are provided with the vertically folded check valve tabs 10. The two check valve tabs 10 on each of the plurality of rectangular openings 11 are respectively attached to a left side wall of a corresponding one of the pressure relief cavity assemblies and a right side wall of an adjacent one of the pressure relief cavity assemblies. The length of each of the check valve tabs 10 is smaller than a length of a respective one of the rectangular openings 11. A middle portion of each of the check valve tabs 10 connects to a respective one of the rectangular openings 11, and each of two end portions of each of the check valve tabs 10 and a respective one of the rectangular openings 11 define a slot gap 12. In this configuration, a narrow middle portion of each of the check valve tabs 10 is connected to the check valve heat sink plate 3. Because the narrow portion provides only a small force, each of the check valve tabs 10 can be directly forced open in one direction for pressure relief. Moreover, because the length of each of the check valve tabs 10 is greater than the distance between the two valve body stoppers 9 on the pressure relief hole 8, each of the check valve tabs 10 can be forced open only from the inside, but cannot be forced open from the outside.

In this embodiment, the temperature-resistant pressure relief module 2 is a fire-resistant high-temperature-resistant thermally insulating rectangular plate. A spacer block 13 is disposed between the two valve body stoppers 9 of each of the pressure relief cavity assemblies. The pressure relief hole 8 extends through the fire-resistant high-temperature-resistant thermally insulating rectangular plate and the spacer block 13. Both outer sides and an upper end of the fire-resistant high-temperature-resistant thermally insulating rectangular plate are provided with sealing baffles 14. This configuration further prevents ejected material from a faulty cell 6 from entering normal cells 6. A middle portion of the spacer block 13 is provided with a groove strip. Each of the check valve tabs 10 is vertically folded and attached between the two valve body stoppers 9. A front end of each of the check valve tabs 10 is vertically folded to form a locking strip configured to fit into the groove strip. This configuration allows each of the check valve tabs 10 to better fit between the two valve body stoppers 9. Moreover, when a cell 6 undergoes thermal runaway, the generated high-speed gas flow and heat can easily blow the locking strip out of the groove strip.

In this embodiment, the check valve heat sink plate 3 is integrally formed. The manufacturing process is as follows: a rectangular plate having an outer shape matching the temperature-resistant pressure relief module 2 is made of a highly thermally conductive material; positions of the rectangular openings 11 are marked; upper and lower portions at the marked positions of the rectangular openings are cut away; a middle portion of each of the rectangular openings 11 is cut to form two check valve tabs 10 to be folded; slot gaps 12 are formed at two end portions of each of the check valve tabs 10; the check valve tabs 10 are vertically folded using a press brake; and front ends of the check valve tabs 10 are folded again to form locking strips. The overall processing is convenient and the manufacturing cost is low.

In this embodiment, a plurality of bus bars 15 are further disposed between the battery securing module 1 and the temperature-resistant pressure relief module 2. The cells are welded in single rows and are connected together by the bus bars 15 at top portions. Each of the bus bars 15 is configured to connect cells 6 in the same row in series. Each of the bus bars 15 is provided with a plurality of opening holes having a diameter greater than or adapted to a diameter of the pressure relief hole 8. When a cell 6 is damaged, it is not necessary to replace the entire battery module; only the single row needs to be replaced, which can greatly reduce subsequent maintenance costs.

In this embodiment, the battery box includes a box housing 16. A plurality of mounting compartments 17 are provided in the box housing 16. The battery module is installed in each of the plurality of mounting compartments 17. Each of two ends of a bottom portion of the battery module is provided with a heat dissipation spacer block 18. A longitudinal one of the pressure relief guide grooves 7 is disposed between two adjacent heat dissipation spacer blocks 18 at the same end. A pressure relief valve 19 is provided at a center of a bottom portion of each of the plurality of mounting compartments 17. The battery box further includes a cover 20 configured to fit the box housing 16. A pressure sensor and a controller are further provided in the box housing 16. The pressure relief valve 19 and the pressure sensor are each electrically connected to the controller. In this configuration, when the pressure sensor detects a pressure reaching a set value, the controller opens the pressure relief valve 19 to discharge pressure and heat to the outside.

Although the embodiments of the present disclosure are described by way of practical examples, such description does not constitute a limitation on the scope of the present disclosure. Modifications to the embodiments and combinations thereof with other implementations based on this specification will be apparent to those skilled in the art.

What is claimed is:

1. A battery module with pressure relief and explosion-proof functions, comprising: a battery securing module, wherein both ends of the battery securing module are sequentially provided with a temperature-resistant pressure relief module, a check valve heat sink plate, and a thermal barrier wall; a plurality of mounting cavities are arranged in an array within the battery securing module, wherein each of the plurality of mounting cavities is provided with a cell fitted therein, and each of the plurality of mounting cavities exposes an end portion of the cell;
the temperature-resistant pressure relief module is attached to the end portion of the battery securing module; the temperature-resistant pressure relief module is provided with a plurality of pressure relief cavity assemblies arranged in an array, and each of the plurality of pressure relief cavity assemblies is disposed at the end portion of the cell;
a plurality of pressure relief guide grooves are provided on a surface of the temperature-resistant pressure relief module facing away from the battery securing module, and the plurality of pressure relief guide grooves intersect each other; a lateral one of the plurality of pressure relief guide grooves is disposed between each two of the laterally adjacent pressure relief cavity assemblies, and a longitudinal one of the plurality of pressure relief guide grooves is disposed between each two of the vertically adjacent pressure relief cavity assemblies; each of the plurality of pressure relief cavity assemblies comprises a pressure relief hole disposed at the end portion of the cell, and two rectangular valve body stoppers disposed at an upper end of the pressure relief hole and a lower end of the pressure relief hole; the two valve body stoppers are mounted on the surface of the temperature-resistant pressure relief module facing away from the battery securing module;
the check valve heat sink plate is configured to match an outer contour of the temperature-resistant pressure relief module and is attached to end portions of the two valve body stoppers; a plurality of vertically folded check valve tabs are arranged in an array on the check valve heat sink plate;
one of the check valve tabs is attached to both sides of the two valve body stoppers on the pressure relief hole, a length of the one of the check valve tabs is greater than a distance between the two valve body stoppers on the pressure relief hole, and a height of each of the check valve tabs is configured to match a height of each of the two valve body stoppers;
whereby, under a joint action of a respective one of the pressure relief cavity assemblies and the check valve heat sink plate, the cell forms an independent pressure relief cavity; when the cell is in a normal state, the check valve tabs of the pressure relief cavity are in a closed and attached state; and when the cell undergoes thermal runaway and ejects material, the check valve tabs are opened to relieve pressure and the ejected material is discharged through the pressure relief guide grooves;
the check valve heat sink plate is integrally formed from a highly thermally conductive material; a plurality of rectangular openings are arranged in an array on the check valve heat sink plate; two side walls of each of the plurality of rectangular openings are provided with the vertically folded check valve tabs; and the two check valve tabs on each of the plurality of rectangular openings are respectively attached to an outer side of a left side wall of a respective one of the valve body stoppers of a corresponding one of the pressure relief cavity assemblies and an outer side of a right side wall of a respective one of the valve body stoppers of an adjacent one of the pressure relief cavity assemblies;
the length of each of the check valve tabs is smaller than a length of a respective one of the rectangular openings; and a middle portion of each of the check valve tabs connects to a respective one of the rectangular openings, and each of two end portions of each of the check valve tabs and a respective one of the rectangular openings define a slot gap; and
the temperature-resistant pressure relief module is a fire-resistant high-temperature-resistant thermally insulating rectangular plate; a spacer block is disposed between the two valve body stoppers of each of the pressure relief cavity assemblies;
the pressure relief hole extends through the fire-resistant high-temperature-resistant thermally insulating rectangular plate and the spacer block; both outer sides and an upper end of the fire-resistant high-temperature-resistant thermally insulating rectangular plate are provided with sealing baffles; a middle portion of the spacer block is provided with a groove strip; and each of the check valve tabs is vertically folded and attached between the two valve body stoppers, and a front end of each of the check valve tabs is vertically folded to form a locking strip configured to fit into the groove strip.

2. The battery module according to claim 1, wherein the battery securing module and the temperature-resistant pressure relief module are each made of a fire-resistant high-temperature-resistant thermally insulating material, and the temperature-resistant pressure relief module is configured to match an end surface of the battery securing module, so that the temperature-resistant pressure relief module is tightly attached to the end surface of the battery securing module; the thermal barrier wall is made of a high-temperature-resistant, low-thermal-conductivity lightweight material; the thermal barrier wall covers the entire check valve heat sink plate to confine heat of the battery module to be directionally released solely through the vertically folded check valve tabs and to be discharged through the pressure relief guide grooves; and the cell is in communication with the plurality of pressure relief guide grooves, such that pressure is configured to be instantly released.

3. The battery module according to claim 1, wherein bus bars are further disposed between the battery securing module and the temperature-resistant pressure relief module, and the bus bars are configured to connect the cells in series.

4. A battery box, comprising: a box housing, wherein a plurality of mounting compartments are provided in the box housing, and the battery module according to claim 1 is installed in each of the plurality of mounting compartments; each of two ends of a bottom portion of the battery module is provided with a heat dissipation spacer block; a longitudinal one of the pressure relief guide grooves is disposed between two adjacent heat dissipation spacer blocks at the same end; and a pressure relief valve is provided at a center of a bottom portion of each of the plurality of mounting compartments.

5. The battery box according to claim 4, further comprising a cover configured to fit the box housing; a pressure sensor and a controller are further provided in the box housing; and the pressure relief valve and the pressure sensor are each electrically connected to the controller.
